(19) United States
(12) Patent Application Publication
(10) Pub. No.: US 2026/0271147 A1
(43) Pub. Date: Sep. 10, 2026

(54) NEW TYPE OF PHASE-CUT DIMMING POWER SUPPLY

(71) Applicant: Zhuhai Demi Technology Co., Ltd., Zhuhai (CN)

(72) Inventors: Hongyu Cheng, Zhuhai (CN); Liutian Liang, Maoming (CN)

(21) Appl. No.: 19/551,862

(22) Filed: Feb. 27, 2026

(30) Foreign Application Priority Data
Feb. 9, 2026 (CN) 202610188167.8

(51) Int. Cl. H05B 45/10; H05B 45/31; H05B 45/325; H05B 45/34; H05B 45/355; H05B 45/385

(52) U.S. Cl. CPC H05B 45/10; H05B 45/31; H05B 45/325; H05B 45/34; H05B 45/355; H05B 45/385

(57) ABSTRACT

The present invention relates to the technical field of LED lighting driving, specifically a new type of phase-cut dimming power supply, which includes an AC input filtering and DC conversion circuit, an active power factor correction circuit, a fly-back high-low voltage isolation conversion circuit, a synchronous rectification circuit, a voltage stabilizing circuit, a dimming circuit, a single-chip microcomputer control board, a PWM signal to analog signal circuit, a phase-cut control circuit, and an external load. The present invention can accurately analyze the conduction angle and leading and trailing edge information, significantly improving the detection accuracy, eliminating stroboscopic effects during deep dimming, and expanding the dimming range without flickering. By generating dynamic holding current control data, it can adaptively meet the holding current requirements of different dimmers, ensuring the stable operation of the dimmers while reducing power consumption.

### TECHNICAL FIELD

The present invention relates to the technical field of LED lighting drive, and specifically to a new type of phase-cut dimming power supply.

### BACKGROUND ART

Currently, in the field of LED lighting drivers, phase-cut dimming still occupies a mainstream market position due to its compatibility with traditional incandescent dimming systems. Existing phase-cut dimming power supply technologies usually mainly include the following structures: EMI filtering and rectifier circuits at the input end, bleeder circuits for maintaining the conduction of thyristors, power factor correction circuits, DC-DC conversion circuits, and output rectification and filtering circuits.

In terms of control methods, most existing phase-cut dimming power supplies adopt analog detection technology or basic digital detection technology. A typical approach is to perform voltage division sampling on the input AC voltage, use an RC filter circuit to smooth the phase-cut voltage waveform into a DC level, and then a single-chip microcomputer or a dedicated control chip determines the phase-cut angle by detecting the magnitude of this DC level to further adjust the output current of the power supply. In addition, to prevent the thyristor dimmer from being mistakenly turned off due to too small current at a low conduction angle, existing technologies usually use a fixed resistance-capacitance bleeder circuit or a simple active bleeder circuit to provide the holding current. In terms of signal processing, traditional PWM-to-analog signal conversion mostly uses simple resistance-capacitance filtering or ordinary optocoupler isolation transmission, resulting in limited precision and response speed.

Although the above-mentioned existing technologies can realize basic phase-cut dimming functions, there are still the following obvious technical defects and deficiencies in practical applications:

Low detection accuracy and limited dimming range: The existing analog RC filter detection method has a large phase lag, which cannot restore the real details of the phase-cut waveform in real time. Especially in the small conduction angle (deep dimming) region, it is extremely vulnerable to the interference of input voltage noise and ripple, resulting in an unsmooth dimming curve, often accompanied by problems such as a narrow dimming range, severe flicker at low brightness, and even light jitter.

Poor compatibility and weak adaptability: There are many brands of phase-cut dimmers on the market, with different internal resistance characteristics, holding current requirements, and leading/lagging edge triggering methods. The existing fixed bleeder circuits cannot dynamically adjust the magnitude of the holding current according to the characteristics of different dimmers. If the bleeder current is too large, it will lead to reduced system efficiency and severe heat generation; if the bleeder current is too small, it will cause the dimmer to reset erroneously during the phase-cutting process, resulting in flickering or “ghosting” phenomena.

Inaccurate leading and trailing edge identification: Traditional detection circuits often struggle to accurately distinguish between leading-edge phase cutting and trailing-edge phase cutting, or require additional complex hardware circuits for identification. This causes the power supply to be unable to automatically match the optimal control strategy when faced with different types of dimmers, affecting the user experience.

Insufficient stability of signal conversion: In the control signal transmission link, the traditional PWM to analog circuit has poor linearity, is greatly affected by temperature and component aging, which easily leads to output current drift, and is prone to loss of signal accuracy during isolated transmission, making it difficult to meet the requirements of high-precision dimming.

Therefore, there is an urgent need to improve the phase-cut dimming power supply to solve the above-mentioned problems.

### CONTENT OF THE INVENTION

The purpose of the present invention is to address the defects in the existing technology, such as limited dimming range caused by low detection accuracy of analog RC filter, poor compatibility of fixed bleeder circuits, difficulty in identifying leading and trailing edges, poor linearity of signal conversion, and insufficient stability. It provides a new type of phase-cut dimming power supply, which uses algorithm-fused data to realize digital restoration of waveforms, can accurately parse the conduction angle and leading and trailing edge information, significantly improves the detection accuracy, and eliminates stroboscopic effects during deep dimming. At the same time, it can adaptively meet the holding current requirements of different dimmers, ensuring the stable operation of the dimmers while minimizing power consumption. The new PWM signal to analog signal circuit is adopted, which greatly improves the linearity and anti-interference ability of signal conversion, ensures stable output, and achieves high-compatibility and high-precision phase-cut dimming effects.

To achieve the above objectives, the main technical solutions adopted by the present invention include:

A new type of phase-cut dimming power supply, including AC input filtering and DC conversion circuit, active power factor correction circuit, flyback high-low voltage isolation conversion circuit, synchronous rectification circuit, voltage stabilization circuit, dimming circuit, single-chip microcomputer control board, PWM signal to analog signal circuit, phase-cut control circuit, and external load,

The output end of the said AC input filtering and DC conversion circuit is connected to the input end of the said active power factor correction circuit;

The output end of the active power factor correction circuit is connected to the input end of the flyback high-low voltage isolation conversion circuit;

The output terminal of the flyback high-low voltage isolation conversion circuit is connected to the input terminal of the synchronous rectification circuit.

The output terminal of the synchronous rectification circuit is connected to the input terminal of the voltage stabilizing circuit;

The output end of the voltage stabilizing circuit is connected to the input end of the flyback high-low voltage isolation conversion circuit;

The output terminal of the synchronous rectification circuit is connected to the input terminal of the external load;

The input end of the dimming circuit is connected to the output end of the external load;

The control output terminal of the single-chip microcomputer control board is connected to the input terminal of the dimming circuit;

The output end of the aforesaid AC input filtering and DC conversion circuit is connected to the input end of the aforesaid phase-cut control circuit;

The output end of the phase-cut control circuit is connected to the input end of the PWM signal to analog signal circuit;

The output end of the aforementioned PWM signal to analog signal circuit is connected to the input end of the aforementioned single-chip microcomputer control board.

Compared with the prior art, the present invention has at least the following beneficial effects: realizing digital waveform restoration by fusing data with an algorithm, which can accurately parse the conduction angle and leading/trailing edge information, significantly improve the detection accuracy, eliminate the stroboflash during deep dimming, and broaden the flicker-free dimming range. At the same time, by generating dynamic holding current control data, the present invention can adapt to the holding current requirements of different dimmers, which not only ensures the stable operation of the dimmer but also reduces the power consumption to the greatest extent. In addition, a novel PWM signal to analog signal conversion circuit is adopted, which greatly improves the linearity and anti-interference ability of signal conversion, ensures the output stability, and achieves a high-compatibility and high-precision phase-cut dimming effect.

### BRIEF DESCRIPTION OF THE DRAWINGS

The drawings described herein are used to provide a further understanding of the present application and constitute a part of the present application. The illustrative embodiments of the present application and their descriptions are used to explain the present application and do not constitute an improper limitation of the present application. In the drawings:

FIG. 1 is a structural framework diagram of the novel phase-cut dimming power supply of the present invention;

FIG. 2 is an overall circuit diagram of the novel phase-cut dimming power supply of the present invention;

FIG. 3 is a circuit diagram of the AC input filtering and DC conversion circuit in FIG. 2;

FIG. 4 is a circuit diagram of the active power factor correction circuit in FIG. 2;

FIG. 5 is a circuit diagram of the flyback high-low voltage isolation conversion circuit in FIG. 2;

FIG. 6 is a circuit diagram of the synchronous rectification circuit in FIG. 2;

FIG. 7 is a circuit diagram of the voltage stabilization circuit in FIG. 2;

FIG. 8 is a circuit diagram of the dimming circuit in FIG. 2;

FIG. 9 is a circuit diagram of the single-chip microcomputer control board circuit in FIG. 2;

FIG. 10 is a circuit diagram of the PWM signal to analog signal conversion circuit in FIG. 2;

FIG. 11 is a circuit diagram of the phase-cut control circuit in FIG. 2.

In the figures: 1—AC input filtering and DC conversion circuit; 2—active power factor correction circuit; 3—fly-back high-low voltage isolation conversion circuit; 4—synchronous rectification circuit; 5—voltage stabilization circuit; 6—dimming circuit; 7—single-chip microcomputer control board; 8—PWM signal to analog signal conversion circuit; 9—phase-cut control circuit; 10—external load.

### DETAILED DESCRIPTION OF THE EMBODIMENTS

The embodiments of the present application will be described in detail below in conjunction with the accompanying drawings and embodiments, so as to fully understand and implement the process of how the present application applies technical means to solve technical problems and achieve technical effects.

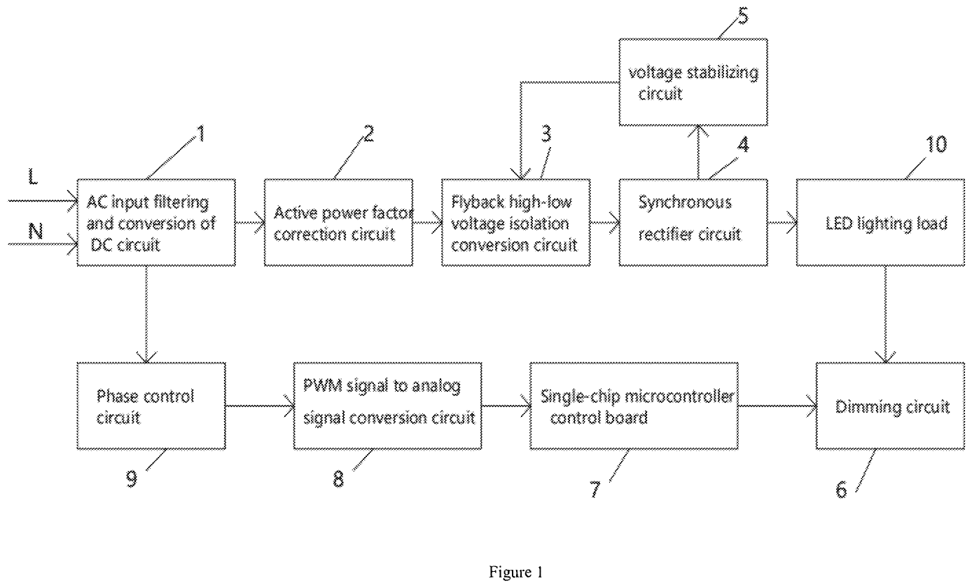

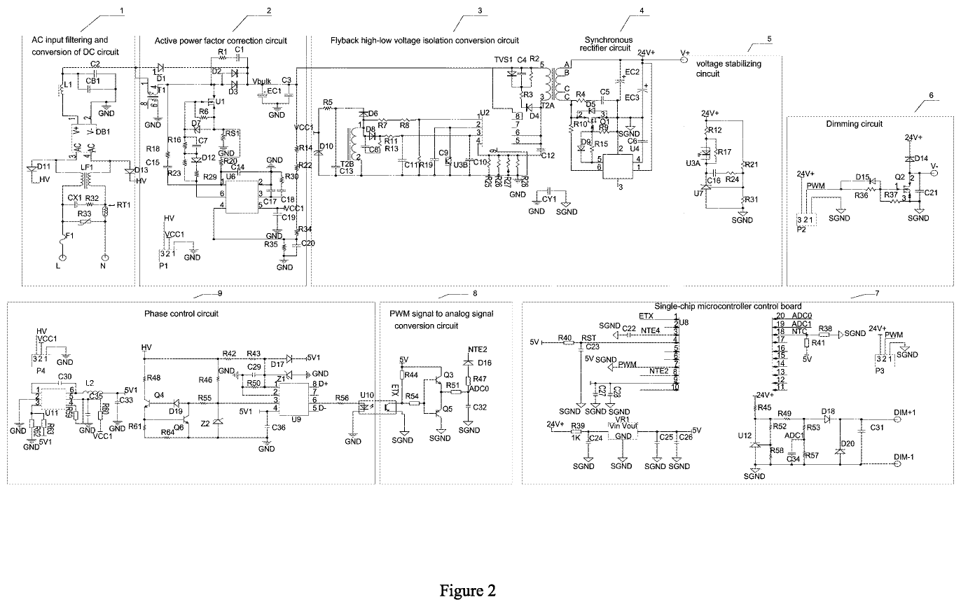

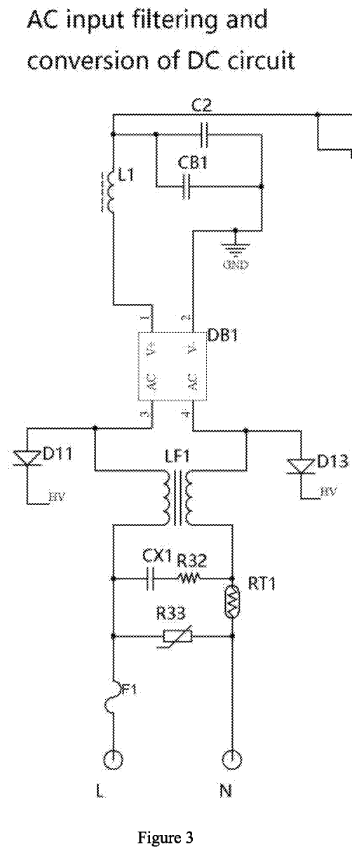

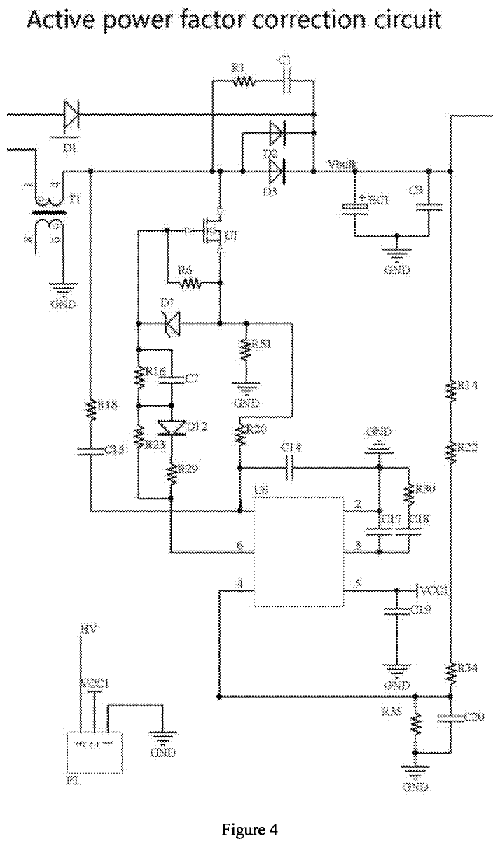

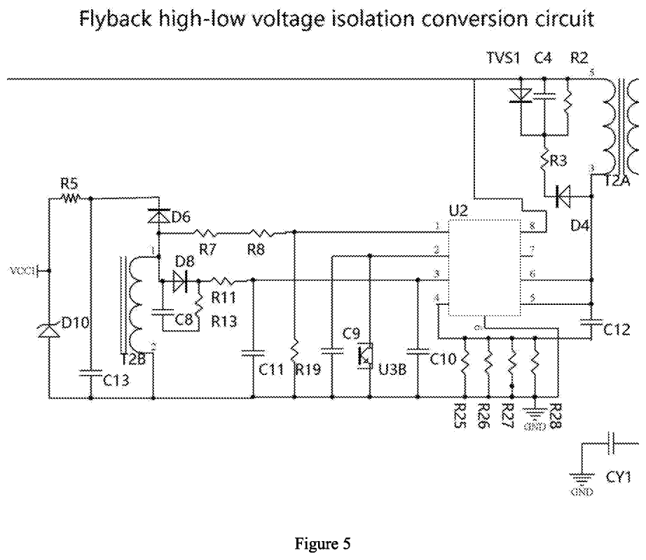

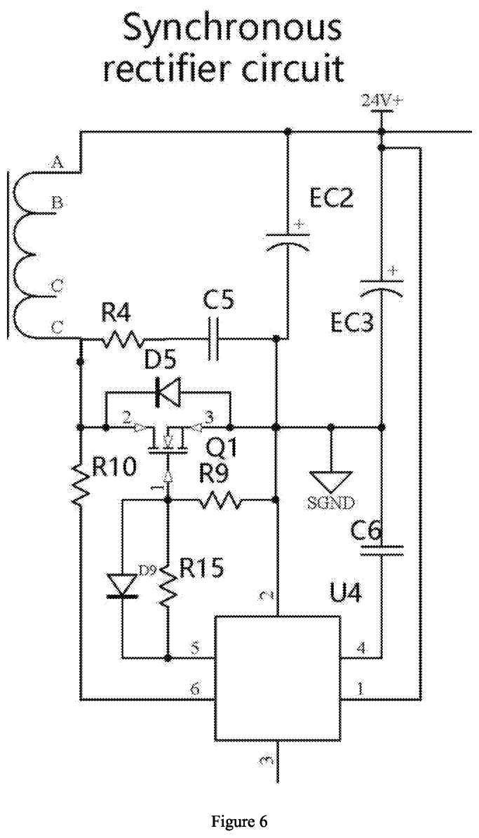

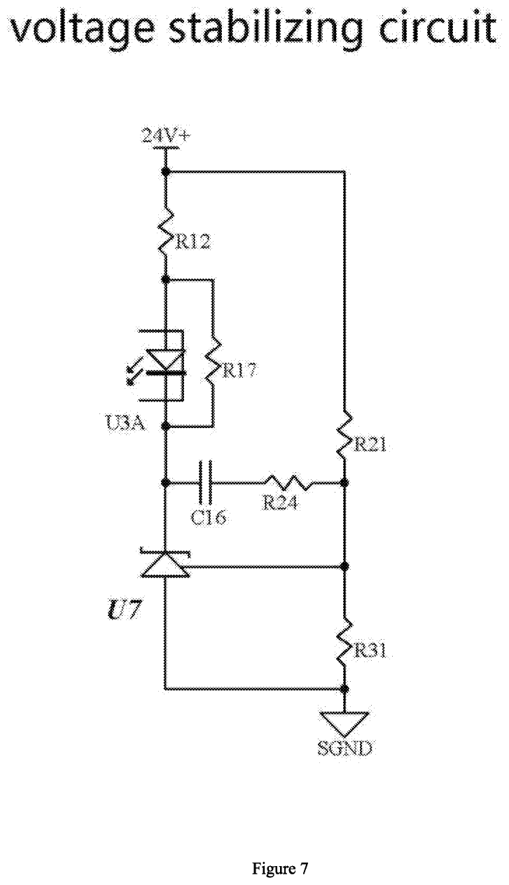

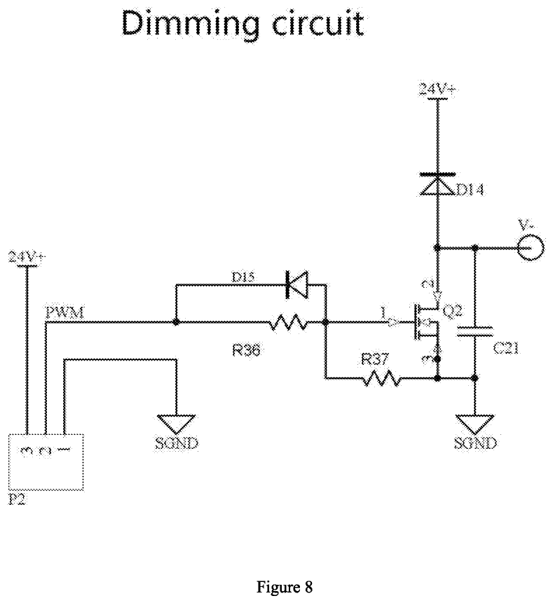

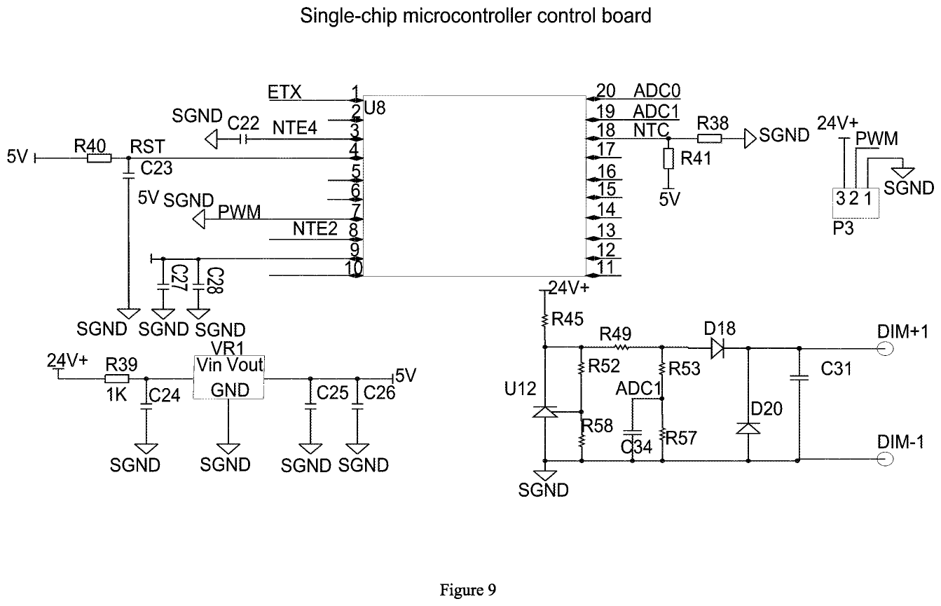

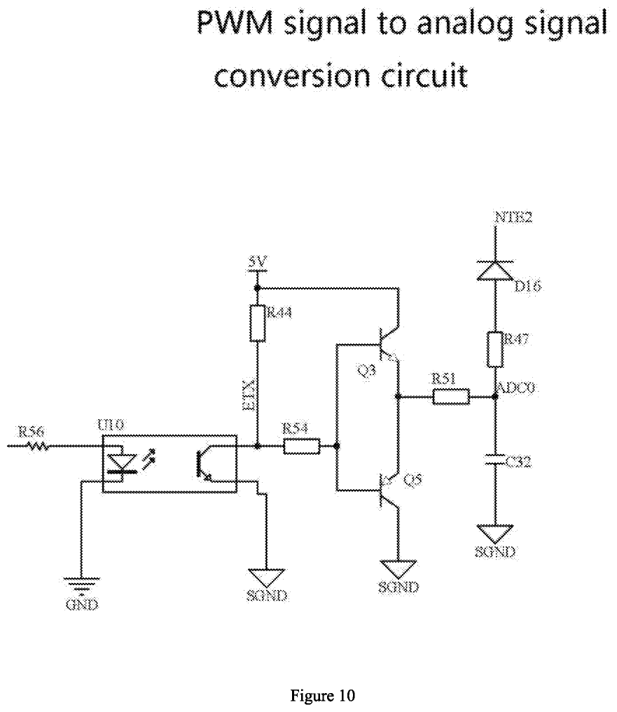

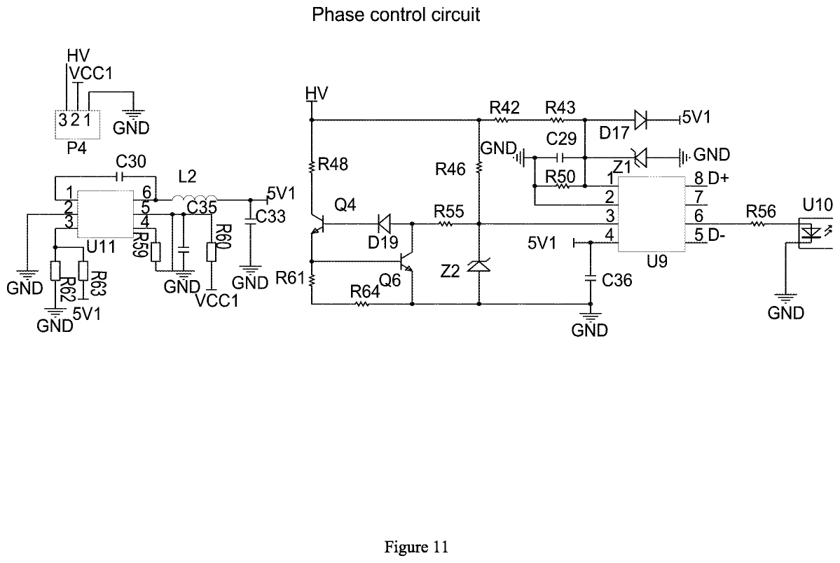

As shown in FIGS. 1-11, the novel phase-cut dimming power supply provided in this embodiment comprises an AC input filtering and DC conversion circuit 1, an active power factor correction circuit 2, a flyback high-low voltage isolation conversion circuit 3, a synchronous rectification circuit 4, a voltage stabilization circuit 5, a dimming circuit 6, a single-chip microcomputer control board 7, a PWM signal to analog signal conversion circuit 8, a phase-cut control circuit 9 and an external load 10.

AC input filtering and DC conversion circuit 1: It is used to filter the input commercial AC power, suppress electromagnetic interference (EMI), and convert the AC power into DC power.

Active power factor correction circuit 2: It is used to correct the waveform and phase of the input current to make it follow the input voltage waveform, thereby improving the power factor and reducing the pollution of harmonic current to the power grid.

Flyback high-low voltage isolation conversion circuit 3: It is used to convert high-voltage DC power into low-voltage AC power through a high-frequency transformer, and realize electrical isolation between the input end and the output end to ensure the use safety.

Synchronous rectification circuit 4: It is used to perform rectification on the secondary side of the transformer by using MOSFET switching tubes and a synchronous controller to replace traditional rectifier diodes, reduce rectification loss by using the low on-resistance characteristic of MOSFETs, and improve the power supply efficiency.

Voltage stabilization circuit 5: It is used to sample and feedback adjust the output voltage after the synchronous rectification circuit to ensure the stability of the output voltage/current when the load changes or the input fluctuates.

Dimming circuit 6: It is used to receive the dimming control signal output by the single-chip microcomputer control board 7 and finally control the brightness of the external load 10.

Single-chip microcomputer control board 7: As the core control unit, it is responsible for receiving the phase-cut angle data, performing logical operation, and outputting the corresponding PWM control signal.

PWM signal to analog signal conversion circuit 8: It receives the PWM signal and converts it into an analog signal; its core lies in adopting a specific circuit structure, which can convert the duty cycle change of the digital PWM signal into a high-precision and low-ripple analog voltage signal, thereby realizing high-fidelity signal transmission.

Phase-cut control circuit 9: It collects the phase-cut signal at the input end in real time; secondly, it realizes digital restoration of the phase-cut waveform by fusing sampling data with an internal algorithm; then, it extracts waveform features through an algorithm to accurately parse the conduction angle information (corresponding to dimming brightness) and leading/trailing edge phase-cut type information of the current phase-cut dimmer; at the same time, it generates control data of the holding current circuit according to the parsed features to dynamically control the holding current circuit to ensure the stable operation of the dimmer; finally, it outputs a signal containing brightness information, which can be in the form of a PWM signal, a serial port signal, or other digital coding signals (such as Manchester coding).

External Load 10: it Is an Led Load or a Lighting Load.

The output end of the said AC input filtering and DC conversion circuit 1 is connected to the input end of the said active power factor correction circuit 2;

The output terminal of the active power factor correction circuit 2 is connected to the input terminal of the flyback high-low voltage isolation conversion circuit 3;

The output end of the said flyback high-low voltage isolation conversion circuit 3 is connected to the input end of the said synchronous rectification circuit 4;

The output end of the synchronous rectification circuit 4 is connected to the input end of the voltage stabilizing circuit 5;

The output terminal of the voltage stabilizing circuit 5 is connected to the input terminal of the flyback high-low voltage isolation conversion circuit 3.

The output end of the synchronous rectification circuit 4 is connected to the input end of the external load 10;

The input end of the dimming circuit 6 is connected to the output end of the external load 10;

The control output end of the single-chip microcomputer control small board 7 is connected to the input end of the dimming circuit 6;

The output end of the said AC input filtering and DC conversion circuit 1 is connected to the input end of the said phase-cut control circuit 9;

The output terminal of the phase-cut control circuit 9 is connected to the input terminal of the PWM signal to analog signal circuit 8;

The output terminal of the PWM signal-to-analog signal circuit 8 is connected to the input terminal of the single-chip microcomputer control board 7.

The new phase-cut dimming power supply provided in this embodiment has the following working process, working principle and effect:

AC Input Filtering and DC Conversion Circuit 1: Connect the mains power to AC Input Filtering and DC Conversion Circuit 1 to filter out electromagnetic interference (EMI) and convert alternating current to direct current.

Active Power Factor Correction Circuit 2: Input direct current into the active power factor correction circuit 2, and correct the current waveform and phase through the control circuit.

Flyback High-Low Voltage Isolation Conversion Circuit 3: Input the corrected high-voltage direct current into the flyback high-low voltage isolation conversion circuit 3, and perform step-down and electrical isolation through a high-frequency transformer.

Synchronous rectification circuit 4: Input the isolated and converted low-voltage alternating current into the synchronous rectification circuit 4, and perform rectification using MOSFET switching tubes.

Voltage stabilizing circuit 5: Input the rectified direct current into voltage stabilizing circuit 5, sample it and transmit the feedback signal to the flyback high-low voltage isolation conversion circuit 3 to adjust the output.

MCU control board 7: As the core control unit, it is responsible for receiving phase-cut angle data, performing logical operations, and outputting corresponding PWM control signals.

PWM signal to analog signal circuit 8: receives PWM signals and converts them into analog signals; its core lies in adopting a specific circuit structure, which can convert the duty cycle changes of digital PWM signals into high-precision, low-ripple analog voltage signals, thereby achieving high-fidelity transmission of signals.

Phase-cut control circuit 9: It collects the phase-cut signal at the input end in real time; secondly, it realizes digital restoration of the phase-cut waveform by fusing sampling data with an internal algorithm; then, it extracts waveform features through an algorithm to accurately parse the conduction angle information (corresponding to dimming brightness) and leading/trailing edge phase-cut type information of the current phase-cut dimmer; at the same time, it generates control data of the holding current circuit according to the parsed features to dynamically control the holding current circuit to ensure the stable operation of the dimmer; finally, it outputs a signal containing brightness information, which can be in the form of a PWM signal, a serial port signal, or other digital coding signals (such as Manchester coding).

External load 10: It is an LED load or a lighting load.

The working process, working principle and effect of the novel phase-cut dimming power supply provided in this embodiment are as follows:

Step 1: Firstly, the phase-cut AC power passes through the AC input filtering and DC conversion circuit 1, the electromagnetic interference (EMI) is filtered out by the EMI filter circuit and converted into DC power by the rectifier bridge, thereby providing a pure power input for the subsequent circuit and suppressing the interference of power grid noise on the system. Subsequently, the DC power enters the active power factor correction circuit 2;

Step 2: The waveform and phase of the input current are corrected by the power factor correction technology to make it follow the input voltage waveform, so as to significantly improve the power factor and reduce the pollution of harmonic current to the power grid. Then, the processed high-voltage DC power is input to the flyback high-low voltage isolation conversion circuit 3;

Step 3: The high-voltage power is converted into low-voltage power by using a high-frequency transformer, and the electrical isolation between the input end and the output end is realized at the same time to ensure the electrical safety. The converted low-voltage AC power passes through the synchronous rectification circuit 4, and the rectification is performed by using a MOSFET switching tube with low on-resistance instead of a traditional diode, which effectively reduces the rectification loss and improves the overall conversion efficiency of the power supply. The rectified current is sampled and feedback adjusted by the voltage stabilization circuit 5 to ensure the output stability when the load changes;

Step 4: At the same time, the phase-cut control circuit 9 collects the AC phase-cut voltage waveform in real time, reconstructs the waveform by fusing data with an internal algorithm, parses the conduction angle, leading/trailing edge type and dimming brightness information, and generates holding current control data to ensure the stable conduction of the dimmer and output the dimming signal to a novel PWM signal to analog signal conversion circuit 8 for filtering, which linearly converts the duty cycle change of the digital PWM signal into a high-precision and low-ripple analog voltage signal, thereby realizing high-fidelity signal transmission to the single-chip microcomputer control board 7;

Step 5: The single-chip microcomputer control board 7 is responsible for receiving the dimming signal, performing logical operation, and outputting the corresponding PWM dimming control signal to the dimming circuit 6, and adjusting the magnitude of the output current flowing to the external load 10 or the on-off duty cycle accordingly, thereby realizing the control of the load brightness.

The present invention has the following beneficial effects: realizing digital waveform restoration by fusing data with an algorithm, which can accurately parse the conduction angle and leading/trailing edge information, significantly improve the detection accuracy, eliminate the stroboflash during deep dimming, and broaden the flicker-free dimming range. At the same time, by generating dynamic holding current control data, the present invention can adapt to the holding current requirements of different dimmers, which not only ensures the stable operation of the dimmer but also reduces the power consumption to the greatest extent. In addition, a novel PWM signal to analog signal conversion circuit is adopted, which greatly improves the linearity and anti-interference ability of signal conversion, ensures the output stability, and achieves a high-compatibility and high-precision phase-cut dimming effect.

The above are only the preferred embodiments of the present invention and are not intended to limit the present invention in any form. Although the present invention has been disclosed above with the preferred embodiments, it is not intended to limit the present invention. Any person skilled in the art can make slight changes or modifications to equivalent embodiments with equivalent changes by using the technical contents disclosed above without departing from the scope of the technical solution of the present invention. However, any brief modification, equivalent change and modification made to the above embodiments according to the technical essence of the present invention without departing from the content of the technical solution of the present invention shall still fall within the scope of the technical solution of the present invention.

1. A new type of phase-cut dimming power supply, characterized by comprising an AC input filtering and DC conversion circuit (1), an active power factor correction circuit (2), a fly-back high-low voltage isolation conversion circuit (3), a synchronous rectification circuit (4), a voltage stabilizing circuit (5), a dimming circuit (6), a single-chip microcomputer control board (7), a PWM signal to analog signal circuit (8), a phase-cut control circuit (9), and an external load (10).
The output end of the AC input filtering and DC conversion circuit (1) is connected to the input end of the active power factor correction circuit (2);
The output end of the active power factor correction circuit (2) is connected to the input end of the fly-back high-low voltage isolation conversion circuit (3);
The output end of the fly-back high-low voltage isolation conversion circuit (3) is connected to the input end of the synchronous rectification circuit (4);
The output end of the synchronous rectification circuit (4) is connected to the input end of the voltage stabilizing circuit (5);
The output terminal of the voltage stabilizing circuit (5) is connected to the input terminal of the fly-back high-low voltage isolation conversion circuit (3);
The output end of the synchronous rectification circuit (4) is connected to the input end of the external load (10);
The input end of the dimming circuit (6) is connected to the output end of the external load (10);
The control output terminal of the single-chip microcomputer control small board (7) is connected to the input terminal of the dimming circuit (6);
The output end of the aforesaid AC input filtering and DC conversion circuit (1) is connected to the input end of the phase-cut control circuit (9);
The output terminal of the phase-cut control circuit (9) is connected to the input terminal of the PWM signal-to-analog signal circuit (8);
The output end of the PWM signal to analog signal circuit (8) is connected to the input end of the single-chip microcomputer control board (7).
